(19) United States
(12) Patent Application Publication
(10) Pub. No.: US 2022/0261295 A1
(43) Pub. Date: Aug. 18, 2022

(54) METHOD AND SYSTEM FOR AI BASED AUTOMATED CAPACITY PLANNING IN DATA CENTER

(71) Applicant: QPICLOUD TECHNOLOGIES PRIVATE LIMITED, Bangalore (IN)

(72) Inventors: Nagendra Nagaraja, Bangalore (IN); Abhinand Balachandran, Coimbatore (IN)

(21) Appl. No.: 17/666,527

(22) Filed: Feb. 7, 2022

(30) Foreign Application Priority Data
Feb. 5, 2021 (IN) 202141004948

(51) Int. Cl. G06F 9/50; G06F 9/455; G06F 11/34; G06K 9/62

(52) U.S. Cl. CPC G06F 9/5077; G06F 9/45558; G06F 11/3409; G06K 9/6262; G06F 2201/815; G06F 2009/4557; G06F 2209/501; G06F 2209/503; G06F 2201/81; G06K 9/6223

(57) ABSTRACT

Disclosed is a system and method for capacity planning based on intelligent feedback and analytics. The system clusters one or more resources (such as virtual machines) based on utilization to identify and group together resources with similar behavior. The system scores an efficiency of each resource based on utilization or characterizing the resource type. The system characterizes the workloads. The system develops a reinforcement learning based agent to help make capacity planning decisions by utilizing the steps of clustering, efficiency scoring and characterization.

### CROSS-REFERENCE TO RELATED APPLICATIONS

The embodiments herein claim the priority of the Indian Provisional Patent Application numbered IN 202141004948 filed on Feb. 5, 2021, with the title “METHOD AND SYSTEM FOR AI BASED AUTOMATED CAPACITY PLANNING IN DATA CENTER”, and the contents of which are included entirely as reference herein.

### BACKGROUND

### Technical Field

The embodiments herein are generally related to a field of management of networked computer systems. The embodiments herein are particularly related to method and system for capacity planning in a datacenter. The embodiments herein are more particularly related to method and system and apparatus for AI based automated capacity planning in a datacenter based on intelligent feedback and analytics.

### Description of the Related Art

Typically, large scale online services include many servers distributed among various locations at data centers. The servers may receive and fulfill millions of requests from users each day. A typical large-scale service has a multi-tier architecture to achieve performance isolation and facilitate systems management. Owing to the complexity of these large-scale online services, most often the planners find it difficult to predict service performance when the large-scale services experience a reconfiguration, disruption, or other changes. Additionally, the planners currently lack adequate tools to identify and measure service performance, which may be used to make strategic decisions about the services.

Moreover, massively scalable applications create many new challenges in managing user loads and storage systems in an automated fashion. One such challenge is the ability to accurately predict when capacity will be needed in data-heavy applications, such as email, file storage, and online back-up, and also in non-data heavy applications. Making this prediction is difficult because the limitations which can affect available overall load take many forms, including utilization of processor, memory, input/output load (comprising reads per second, writes per second, total transactions per second, and number of ports being utilized), network space, disk space, an application or applications, and power, and these forms are continually changing.

Hence there is need for a method and a system for optimal capacity planning based on intelligent feedback and analytics in datacenters.

The above-mentioned shortcomings, disadvantages and problems are addressed herein, and which will be understood by reading and studying the following specification.

### OBJECTS OF THE EMBODIMENTS HEREIN

The primary object of the embodiments herein is to provide a method and system for capacity planning based on intelligent feedback and analytics in a datacenter.

Another object of the embodiments herein is to provide a method and a system for capacity planning based on an intelligent feedback along with the analytics provided in workload characterization and resource clustering that enables the end user (datacenter manager) to make appropriate decisions to keep the datacenter performing efficiently.

Yet another object of the embodiments herein is to provide a method and a system for capacity planning based on an intelligent feedback that enables the datacenter to elastically scale up and down in an effective way.

Yet another object of the embodiments herein is to provide a method and a system for capacity planning based on an intelligent feedback along with analytics provided in workload characterization and resource clustering, such that the resource clusters and efficiency scores of the virtual machines involved helps to spot inefficient regions in the datacenter.

Yet another object of the embodiments herein is to provide a method and a system for capacity planning in a datacenter that helps in understanding the type of workloads running in the datacenter which on its own can be used for analyzing application performances, capacity planning by studying certain workloads, it can help in a possible migrating of these services in future.

Yet another object of the embodiments herein is to provide a method and a system for capacity planning in datacenter that enables to maintain the datacenter in a cost-effective manner by facilitating easy spotting of problematic areas.

Yet another object of the embodiments herein is to provide a method and a system to that can help bring down the carbon footprint of the datacenter by keeping it more efficient.

These and other objects and advantages of the embodiments herein will become readily apparent from the following detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The various embodiments herein provide a system and a method for capacity planning based on intelligent feedback and analytics in a datacenter.

The various embodiments herein provide, a system for capacity planning based on intelligent feedback and analytics in a datacenter comprising a clustering module configured to cluster plurality of resources based on utilization and to identify and group together the plurality of resources with similar behaviour. The plurality of resources comprises virtual machines or VMs. Further, the system comprises an efficiency scoring module configured to score efficiency of each plurality of resources based on utilization. The efficiency score of the efficiency scoring module enables to spot inefficient regions in a datacenter. The datacenter is defined as a large group of networked computer servers typically used by organizations for remote storage, processing, or distribution of large amount of data. In addition, the system comprises of a workload characterization module configured to characterize a set of workloads to identify the nature of the set of workload. The set of workloads is defined as applications or services or tasks that are running in the datacenter and consumes the plurality of resources. Moreover, the system comprises of a reinforcement learning module configured to generate a reinforcement learning based agent or RL agent to make capacity planning decisions based on the inputs from clustering module, efficiency scoring module and the workload characterisation module. The reinforcement learning agent or RL agent is an algorithm interacting with the environment by means of taking actions, and wherein the action includes increasing or decreasing the capacity of plurality of resources.

According to one embodiment herein, the clustering the plurality of resources in the cluster module involves utilizing the plurality of resources historical time series data such as CPU, Memory and/or Disk input/output that are behaving in similar ways are grouped together based on the similarity scores. Further, in the clustering module the historical time series data is given as an input to TS (Time Series) clustering algorithm to generate K-clusters by means of k-Means algorithm based on utilization of the plurality of resources. The k-Means algorithm in addition to the historical time series data utilizes an additional input hyperparameter k to generate K-clusters. The hyperparameter k denotes the number of clusters to be formed and the k-means algorithm is k-Means clustering with Dynamic Time Warping (DTW) or k-Means Soft-DTW. Furthermore, the the K-clusters is used as an input to generate a cluster-wise analytics. Therefore, the cluster-wise analytics generated by the K-clusters helps to provide common insights such as number of plurality of resources being underutilized, number of plurality of resources being overloaded, number of underutilized plurality of resources contributing to the electricity bill, number of host that contribute most to the costs while being underutilized and parts of the datacenter with identical load patterns.

According to one embodiment herein, the efficiency score in the efficiency scoring module is calculated by: a) assigning thresholds or bins for scoring each plurality of resource such as VMs, for instance 0-30 indicates Low, 31-70 indicates Medium, 70-100 indicates High; b) evaluating number of values that fall in assigned bins for each plurality of resources; c) considering probabilities of values that fall within each assigned bin; d) multiplying the probabilities for each assigned bin with weights to obtain an efficiency score and the efficiency score helps to filter out low category resources and emphasizes higher categories, thereby essentially making the score high for high probability values in high category and low probability values in low category; e) obtaining the efficiency score for all the plurality of resources separately following the steps (a-d); f) assigning average of efficiency score for all the plurality of resources as an overall score. Typically, the score ranges between 0 and 1, and the score near to 1 indicates good utilization of plurality of resources, score of 0.5 indicates medium utilization of plurality of resources and score near to 0 indicates poor utilization of plurality of resources. Hence, once the plurality of resources or VMs are scored the clusters can be analyzed based on the respective efficiency scores of the VMs. This enables spotting inefficient regions in the datacenter and more information can be inferred from the efficiency scores that can help in capacity planning.

According to one embodiment herein, the characterization of set of workload in a workload characterization module comprises of performing workload clustering and analysis to generate workload classification. The workload classification helps in capacity management, optimizing performance and resource availability in the datacenter. Besides, workload classification the workload characterization module takes into consideration how the resources are getting utilized and the actual workloads that are causing the behavior. Thus, it becomes important to characterize the workload types in order to effectively do capacity management. On its own this can be very useful in elastically scaling the datacenter's provisioned resources according to the workload behavior. Furthermore, the data used for characterization of set of workload includes total runtime of each task, CPU, Memory and Disk IO peaks and averages during runtime. By characterization the goal is to identify the nature of workload. Moreover, the characterization of set of workloads comprises clustering-based characterization or scoring-based characterization to identify the workload distribution of the datacenter. The clustering-based characterization provides number of combinations of workload that are variable and the scoring-based characterization provides number of combinations of workload that are fixed.

According to one embodiment herein, the reinforcement learning (RL) based approach in reinforcement learning module is used to optimize the capacity parameters to increase the overall efficiency of the datacenter. The main characteristics of the reinforcement learning module is an RL agent (algorithm) interacting with the environment (the problem setting) by means of taking actions (increasing or decreasing the capacity of VMS) by which the RL agent gets to directly influence the environment. Depending upon the actions taken by the reinforcement learning agent or RL agent, the RL agent perceives a reward signal. The reward signal comprises sum of all plurality of resources efficiency scores. Hence, the objective of the RL agent is to maximize the cumulative reward after multiple iterations to make most suitable capacity planning decisions over time and the capacity planning decisions increases the overall efficiency of the datacenter.

According to one embodiment herein, the method for capacity planning based on intelligent feedback and analytics in a datacenter comprises the steps of: clustering plurality of resources based on utilization to identify and group together the plurality of resources with similar behaviour. The plurality of resources comprises virtual machines or VMs. The next step in the method involves calculating efficiency score for each plurality of resources based on utilization. The efficiency score thus, enables to spot inefficient regions in a datacenter. The datacenter is a large group of networked computer servers typically used by organizations for remote storage, processing, or distribution of large amount of data. Further, the method encompasses characterizing a set of workload to identify the nature of the set of workload. The set of workloads comprises applications or services or tasks that are running in the datacenter and consumes the plurality of resources. Finally, developing a reinforcement learning based agent or RL agent to make capacity planning decisions based on the inputs from clustering, scoring and characterizing the set of workload. The reinforcement learning agent or RL agent is an algorithm interacting with the environment by means of taking actions and the action includes increasing or decreasing the capacity of plurality of resources or VMs.

Therefore, the embodiments herein provide system and method for capacity planning based on intelligent feedback and analytics. The intelligent feedback along with the analytics provided in workload characterization and resource clustering helps an end user (datacenter manager) to make appropriate decisions to keep the datacenter performing efficiently. Additionally, the system and method of the present technology enables datacenter to elastically scale up and down in an effective way. Moreover, the system and method of the present technology facilitates reduction in inefficient regions in the datacenter as the clusters and efficiency scores of the VMs can help stop inefficient regions in the datacenter. Also, the present technology facilitates in understanding the type of workloads running in the datacenter which on its own can be used for analyzing application performances, capacity planning by studying certain workloads, it can help in a possible migrating of these services in future. Furthermore, the present technology enables maintaining the datacenter in a cost-effective manner as problematic areas can be easily spotted. Furthermore, the present technology helps in bringing down the carbon footprint of the datacenter by keeping it more efficient.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The other objects, features, and advantages will occur to those skilled in the art from the following description of the preferred embodiment and the accompanying drawings in which:

FIGS. 1A-1C illustrate a block diagram indicating a system architecture of a system for capacity planning based on intelligent feedback and analytics in a datacenter, according to an embodiment herein.

FIG. 1D illustrates a graph of k-means DTW path for a given pair of time series, according to an embodiment herein.

FIGS. 2A-2B illustrate example graphs depicting temporal patterns found within the performance clusters in an exemplary scenario, according to an embodiment herein.

FIG. 3 illustrates a block diagram of a system for capacity planning based on intelligent feedback and analytics in a datacenter, indicating schematic representation of clustering based on workload characterization, according to an embodiment herein.

FIG. 4 illustrates an exemplary graph indicating a workload clustering in google cloud trace dataset, according to an embodiment herein.

FIG. 5 illustrates an exemplary graph corresponding to workloads plotted against clusters, in an exemplary scenario, according to an embodiment herein.

FIG. 6 illustrates a functional block diagram of a reinforcement learning process being modelled as a loop, according to an embodiment herein.

FIG. 7 illustrates a functional block diagram of a markov decision process representing RL agent training, according to an embodiment herein.

FIG. 8 illustrates a functional block diagram representing a process of iteratively training the RL agent, according to an embodiment herein.

FIG. 9 illustrates a functional block diagram representing a process of RL agent inference, according to an embodiment herein.

FIG. 10 illustrates a flow chart explaining a process of capacity planning based on intelligent feedback and analytics, according to an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS HEREIN

The detailed description of various exemplary embodiments of the disclosure is described herein with reference to the accompanying drawings. It should be noted that the embodiments herein are described herein in such details as to dearly communicate the disclosure. However, the amount of details provided herein is not intended to limit the anticipated variations of the embodiments herein; on the contrary, the intention is to cover all modifications, equivalents, and alternatives falling within the spirit and scope of the embodiments herein as defined by the appended claims.

It is also to be understood that various arrangements may be devised that, although not explicitly described or shown herein, embody the principles of the embodiments herein. Moreover, all statements herein reciting principles, aspects, and the embodiments of herein, as well as specific examples, are intended to encompass equivalents thereof.

While the embodiments herein are susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternatives falling within the scope of the embodiments herein.

The various embodiments herein provide a system and a method for capacity planning based on intelligent feedback and analytics in a datacenter.

The various embodiments herein provide, a system for capacity planning based on intelligent feedback and analytics in a datacenter comprising a clustering module configured to cluster plurality of resources based on utilization and to identify and group together the plurality of resources with similar behaviour. The plurality of resources comprises virtual machines or VMs. Further, the system comprises an efficiency scoring module configured to score efficiency of each plurality of resources based on utilization. The efficiency score of the efficiency scoring module enables to spot inefficient regions in a datacenter. The datacenter is defined as a large group of networked computer servers typically used by organizations for remote storage, processing, or distribution of large amount of data. In addition, the system comprises of a workload characterization module configured to characterize a set of workloads to identify the nature of the set of workload. The set of workloads is defined as applications or services or tasks that are running in the datacenter and consumes the plurality of resources. Moreover, the system comprises of a reinforcement learning module configured to generate a reinforcement learning based agent or RL agent to make capacity planning decisions based on the inputs from clustering module, efficiency scoring module and the workload characterisation module. The reinforcement learning agent or RL agent is an algorithm interacting with the environment by means of taking actions, and wherein the action includes increasing or decreasing the capacity of plurality of resources.

According to one embodiment herein, the clustering the plurality of resources in the cluster module involves utilizing the plurality of resources historical time series data such as CPU, Memory and/or Disk input/output that are behaving in similar ways are grouped together based on the similarity scores. Further, in the clustering module the historical time series data is given as an input to TS (Time Series) clustering algorithm to generate K-clusters by means of k-Means algorithm based on utilization of the plurality of resources. The k-Means algorithm in addition to the historical time series data utilizes an additional input hyperparameter k to generate K-clusters. The hyperparameter k denotes the number of clusters to be formed and the k-means algorithm is k-Means clustering with Dynamic Time Warping (DTW) or k-Means Soft-DTW. Furthermore, the the K-clusters is used as an input to generate a cluster-wise analytics. Therefore, the cluster-wise analytics generated by the K-clusters helps to provide common insights such as number of plurality of resources being underutilized, number of plurality of resources being overloaded, number of underutilized plurality of resources contributing to the electricity bill, number of hosts that contribute most to the costs while being underutilized and parts of the datacenter with identical load patterns.

According to one embodiment herein, the efficiency score in the efficiency scoring module is calculated by: a) assigning thresholds or bins for scoring each plurality of resource such as VMs, for instance 0-30 indicates Low, 31-70 indicates Medium, 70-100 indicates High; b) evaluating number of values that fall in assigned bins for each plurality of resources; c) considering probabilities of values that fall within each assigned bin; d) multiplying the probabilities for each assigned bin with weights to obtain an efficiency score and the efficiency score helps to filter out low category resources and emphasizes higher categories, thereby essentially making the score high for high probability values in high category and low probability values in low category; e) obtaining the efficiency score for all the plurality of resources separately following the steps (a-d); f) assigning average of efficiency score for all the plurality of resources as an overall score. Typically, the score ranges between 0 and 1, and the score near to 1 indicates good utilization of plurality of resources, score of 0.5 indicates medium utilization of plurality of resources and score near to 0 indicates poor utilization of plurality of resources. Hence, once the plurality of resources or VMs are scored the clusters can be analyzed based on the respective efficiency scores of the VMs. This enables spotting inefficient regions in the datacenter and more information can be inferred from the efficiency scores that can help in capacity planning.

According to one embodiment herein, the characterization of set of workload in a workload characterization module comprises of performing workload clustering and analysis to generate workload classification. The workload classification helps in capacity management, optimizing performance and resource availability in the datacenter. Besides, workload classification the workload characterization module takes into consideration how the resources are getting utilized and the actual workloads that are causing the behavior. Thus, it becomes important to characterize the workload types in order to effectively do capacity management. On its own this can be very useful in elastically scaling the datacenter's provisioned resources according to the workload behavior. Furthermore, the data used for characterization of set of workload includes total runtime of each task, CPU, Memory and Disk IO peaks and averages during runtime. By characterization the goal is to identify the nature of workload. Moreover, the characterization of set of workloads comprises clustering-based characterization or scoring-based characterization to identify the workload distribution of the datacenter. The clustering-based characterization provides number of combinations of workload that are variable and the scoring-based characterization provides number of combinations of workload that are fixed.

According to one embodiment herein, the reinforcement learning (RL) based approach in reinforcement learning module is used to optimize the capacity parameters to increase the overall efficiency of the datacenter. The main characteristics of the reinforcement learning module is an RL agent (algorithm) interacting with the environment (the problem setting) by means of taking actions increasing or decreasing the capacity of VMs) by which the RL agent gets to directly influence the environment. Depending upon the actions taken by the reinforcement teaming agent or RL agent, the RL agent perceives a reward signal. The reward signal comprises sum of all plurality of resources efficiency scores. Hence, the objective of the RL agent is to maximize the cumulative reward after multiple iterations to make most suitable capacity planning decisions over time and the capacity planning decisions increases the overall efficiency of the datacenter.

According to one embodiment herein, the method for capacity planning based on intelligent feedback and analytics in a datacenter comprises the steps of: clustering plurality of resources based on utilization to identify and group together the plurality of resources with similar behaviour. The plurality of resources comprises virtual machines or VMs. The next step in the method involves calculating efficiency score for each plurality of resources based on utilization. The efficiency score thus, enables to spot inefficient regions in a datacenter. The datacenter is a large group of networked computer servers typically used by organizations for remote storage, processing, or distribution of large amount of data. Further, the method encompasses characterizing a set of workload to identify the nature of the set of workload. The set of workloads comprises applications or services or tasks that are running in the datacenter and consumes the plurality of resources. Finally, developing a reinforcement learning based agent or RL agent to make capacity planning decisions based on the inputs from clustering, scoring and characterizing the set of workload. The reinforcement learning agent or RL agent is an algorithm interacting with the environment by means of taking actions and the action includes increasing or decreasing the capacity of plurality of resources or VMs.

According to one embodiment herein, the clustering of the plurality of resources involves utilizing the plurality of resources historical time series data such as CPU, Memory and/or Disk input/output that are behaving in similar ways are grouped together based on the similarity scores. Further, during the clustering of the plurality of resources the historical time series data is given as an input to TS (Time Series) clustering algorithm to generate K-clusters by means of k-Means algorithm based on utilization of the plurality of resources. In addition, the k-Means algorithm utilizes an additional input hyperparameter k along with historical time series data to generate K-clusters and the hyperparameter k denotes the number of clusters to be formed. Furthermore, the K-clusters is used as an input to generate a cluster-wise analytics. The cluster-wise analytics generated by the K-clusters helps to provide common insights such as number of plurality of resources being underutilized, number of plurality of resources being overloaded, number of underutilized plurality of resources contributing to the electricity bill, number of host that contribute most to the costs while being underutilized and parts of the datacenter with identical load patterns.

According to one embodiment herein, the calculating efficiency score in the method for capacity planning based on intelligent feedback and analytics in a datacenter comprises the steps of: a) assigning thresholds or bins for scoring each plurality of resource such as VMs, for instance 0-30 indicates Low, 31-70 indicates Medium, 70-100 indicates High; b) evaluating number of values that fall in assigned bins for each plurality of resources; c) considering probabilities of values that fall within each assigned bin; d) multiplying the probabilities for each assigned bin with weights to obtain an efficiency score and the efficiency score helps to filter out low category resources and emphasizes higher categories, thereby essentially making the score high for high probability values in high category and low probability values in low category; e) obtaining the efficiency score for all the plurality of resources separately following the steps (a-d); and f) assigning average of efficiency score for all the plurality of resources as an overall score. Typically, the score ranges between 0 and 1, and the score near to 1 indicates good utilization of plurality of resources, score of 0.5 indicates medium utilization of plurality of resources and score near to 0 indicates poor utilization of plurality of resources. Hence, once the plurality of resources or VMs are scored the clusters can be analyzed based on the respective efficiency scores of the VMs. This enables spotting inefficient regions in the datacenter and more information can be inferred from the efficiency scores that can help in capacity planning.

According to one embodiment herein, the characterizing the set of workload in the method for capacity planning based on intelligent feedback and analytics in a datacenter includes performing workload clustering and analysis to generate workload classification. The workload classification helps in capacity management, optimizing performance and resource availability in the datacenter. Besides, the workload classification the method takes into consideration how the resources are getting utilized and the actual workloads that are causing the behavior. Thus, it becomes important to characterize the workload types in order to effectively carry out capacity management. On its own this can be very useful in elastically scaling the datacenter's provisioned resources according to the workload behavior. Furthermore, the data used for characterizing the set of workload includes total runtime of each task, CPU, Memory and Disk IO peaks and averages during runtime. By characterization the goal is to identify the nature of workload. Moreover, the characterizing the set of workloads comprises clustering-based characterization or scoring-based characterization to identify the workload distribution of the datacenter. The clustering-based characterization provides number of combinations of workload that are variable and the scoring-based characterization provides number of combinations of workload that are fixed.

According to one embodiment herein, developing the reinforcement learning (RL) based agent or RL agent in the method for capacity planning based on intelligent feedback and analytics in a datacenter includes optimization of the capacity parameters to increase the overall efficiency of the datacenter. The reinforcement learning agent or a RL agent is an algorithm interacting with the environment (the problem setting) by means of taking actions such as increasing or decreasing the capacity of VMs, by which the RL agent gets to directly influence the environment. Depending upon the actions taken by the reinforcement learning agent or RL agent, the RL agent perceives a reward signal. The reward signal comprises sum of all plurality of resources efficiency scores. Hence, the objective of the RL agent is to maximize the cumulative reward after multiple iterations to make most suitable capacity planning decisions over time and the capacity planning decisions increases the overall efficiency of the datacenter.

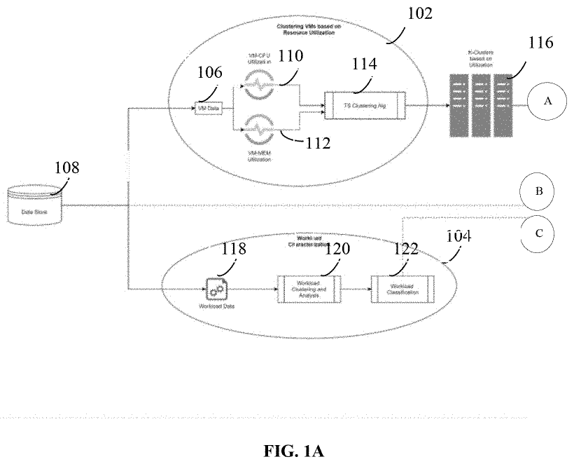

FIGS. 1A-1C illustrate a block diagram depicting a system architecture of a system for capacity planning based on intelligent feedback and analytics in a datacenter, in accordance with an embodiment herein. Stage 102 represents clustering and stage 104 represents workload characterization, by the system of the present technology in the datacenter. During the clustering stage 102, the system groups together the resources such as, virtual machines or VMs based on their historical utilizations that facilitates obtaining interesting information regarding how the resources in the datacenter are being utilized. In an embodiment, the system segregates one or more similarly behaving resources into same performance cluster. For example, the system retrieves virtual machine (VM) data 106 from a data store 108 and segregates the virtual machine data 106 into virtual machine-central processing unit (VM-CPU) utilization data 110 and VM memory (VM-MEM) utilization data 112 and subjects the VM-CPU 110 and VM-MEM 112 into a TS clustering algorithm 114 and generates K-Clusters 116 based on utilization. More analytics on each of these performance clusters can help in obtaining a better understanding of how the resources are getting utilized for an end user or datacenter manager, such as for example, periodical trends in the clusters and how they change over tine which might help planning or migration of these resources when needed. The clustering facilitates spotting the inefficient regions of the datacenter.

Furthermore, clustering the VMs themselves involves using their historical time series data for each resource like CPU, Memory and Disk input/output (I/O). Hence, makes the VMs a multi-variate time series clustering problem where each machine Mᵢ there are two resources Cᵢ and memory Dᵢ where i denotes the i^{th} machine. When we do time series clustering on this data, we will get k different clusters, each cluster that we get depicts a specific category of the utilization for example “Poor”, “Average” and “Good”. Therefore, clustering is an unsupervised task in machine learning where no ground truth labels are required to train the model. This means the algorithm only needs the input time series data. Clustering is done mostly based on similarity scores between the input data points. For general clustering problems where there is no time dimension involved, a similarity score like Euclidean Distance is commonly used for k-Means algorithm but for clustering time series it does not yield good results because each data point is part of an ordered sequence and it doesn't mean much on its own Euclidean distance doesn't take that into account. So, there is a variant of k-Means clustering with Dynamic Time Warping (DTW) metric for calculating similarity scores which is commonly used for such tasks in Machine Learning.

Hence, the way a regular k-Means algorithm works is as follows: 1) Specify number of clusters K; 2) Initialize centroids by first shuffling the dataset and then randomly selecting K data points for the centroids without replacement; 3) Keep iterating until there is no change to the centroids such that the assignment of data points to clusters isn't changing. Further, compute the sum of the squared distance between data points and all centroids. Then assign each data point to the closest cluster (centroid) and finally, compute the centroids for the clusters by taking the average of the all the data points that belong to each cluster. Therefore, the only difference between the regular k-means and the DTW k-means is that the distance calculation is done using an algorithm called Dynamic Time Warping (DTW) because unlike a regular dataset for time series clustering each data point is a time series which has temporal meaning to it rather than being a single point. The DTW between x and y is formulated as the following optimization problem: (where x and y are different time series)

$$DTW ( x , y ) = {min}_{ π} \sqrt{{\sum }_{( i , j ) ∈ π}^{ } } {d ( {x}_{i} , {y}_{i} )}^{2}$$

Hence, a path can be seen as the temporal alignment of time series such that the Euclidean distance between aligned or resampled time series is minimal.

FIG. 1D depicts a graph of DTW path for a given pair of time series, in accordance with an embodiment. FIG. 1D illustrates a graph of DTW path in white for a given pair of time series and on top of the cross-similarity matrix that stores d(xᵢ, yᵢ) values.

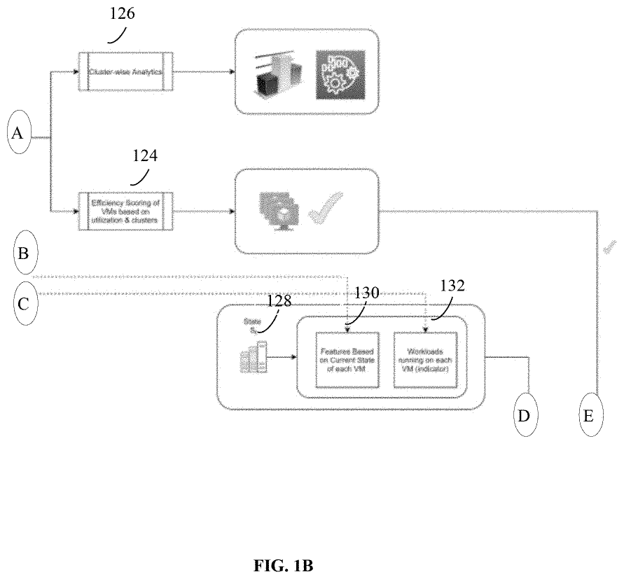

Therefore, consider for instance, if T is the number of time series in total (T machines), N is the length of each time series (Length of the series) and M is the feature dimensionality of the time series (M resources−CPU, Mem etc. . . . ), the input to the k-Means clustering algorithm for carrying out multivariate time series clustering is (T, N, M). In addition, to the multivariate time series input the algorithm also takes another important input, rather a hyperparameter-k which denotes the number of clusters to form. The hyperparameter can be tweaked to obtain optimal clusters. In an embodiment, hyperparameter k for the number of clusters is determined using an elbow method, in which the model is fit for multiple values of k and plotted with error rates on the y-axis and k values are plotted on the x-axis. This plot will look similar to plot depicted in FIG. 2. In elbow method we need to choose the value of k when it first starts to diminish, this point also forms the elbow of the curve. This is based on the assumption that for an optimal value k the error rate will be low enough to indicate that higher k values do not bring a significant reduction in error rates and it turns out to be true in many cases. Once the optimal number of clusters k are determined the model can be trained to fit the data. The output from the algorithm will be a cluster id assigned to each time-series in the dataset. Doing some basic analysis on these clusters makes it clear that the clustering algorithm has identified and grouped together time-series based on the similar patterns observed in them. This information about similarity in resource utilization between VMs in the datacenter can be used by the end user to make potential improvements to the datacenter capacity. A cluster-wise breakdown of information like utilization ranges, trend, seasonality and further visualizations of the VMs based on usage types and user information can help in capacity management.

FIG. 1B illustrates a block diagram representation of efficiency scoring of each resource based on utilization, in accordance with an embodiment herein. During efficiency scoring the system assigns 124 a score to each VM based on how efficiently it is getting utilized. Generally, in datacenters the utilization of resources that are made available has to be high for the datacenter to be efficient, otherwise it means the datacenter resources are not fully being utilized resulting in higher expenses and wastage of resources. For this reason, a higher score should be awarded to VMs that are well utilized and lower for those that are barely getting used. The efficiency score is obtained by 1) choosing the thresholds/bins for scoring each resource in the VMs. Example: [0-30 Low, 31-70 Medium, 70-100 High], 2) Finding how many values fall in each of those bins for each resource in all VMs, 3) Taking the probabilities of values that fall within each bin, 4) Multiplying the probabilities for each bin with weights that drown out low category and emphasizes higher categories essentially making the score high if there is high probability of values in high category and vice versa. Eg: w=[0.1, 0.5, 0.99], 5) Obtaining the efficiency score for all resources separately using this technique, and 6) Assigning the average of efficiency score of all resources as an overall score for the VM. Typically, the score ranges between 0 and 1 for this technique, a value closer to 1 indicating good utilization and values closer to 0 indicating poor utilization of resources. Once the VMs are scored the clusters can be analyzed based on the respective efficiency scores of the VMs as well. This enables spotting inefficient regions in the datacenter and more information can be inferred from the efficiency scores that can help in capacity planning. The system of the present technology further generates a cluster-wise analytics 126 based on the K-clusters. Using a state st from the environment system generates features based on current state of each VM 130 and also generates workloads running on each VM 132 base using data from the datastore 108. The connectors A-E connect various outputs from various blocks in FIGS. 1A-1C as inputs to various other blocks in FIGS. 1A-1C.

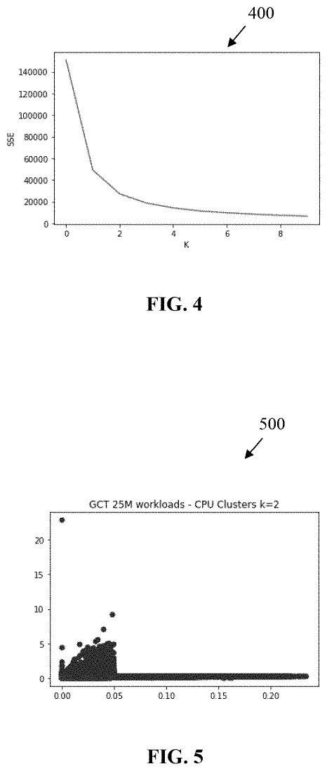

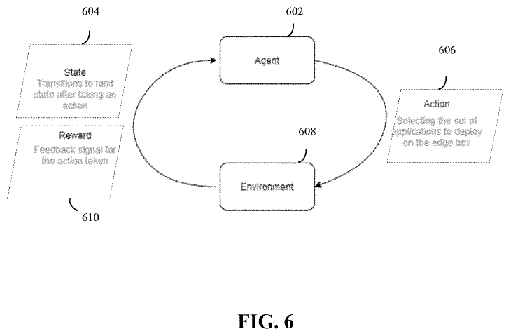

FIG. 1C illustrates a block diagram representation of reinforcement learning in the system of the present technology, in accordance with an embodiment herein. The system tweaks some of the capacity parameters based on the workload characteristics and resource efficiencies for managing the data center in an efficient manner. A reinforcement learning (RL) based approach is used by the present technology to optimize the capacity parameters to increase the overall efficiency of the datacenter. The main characteristics of an RL component of the system is an RL agent (algorithm) interacting with the environment (the problem setting) by means of taking actions (increasing or decreasing the capacity of VMs) by which the RL agent gets to directly influence the environment. Depending upon the actions taken by the RL agent it perceives a reward signal. The reward signal in this case is the sum of all VM efficiency scores. The goal of the RL agent is to maximize the cumulative reward after multiple such iterations which results is the agent making more suitable decisions over time such that the overall efficiency of the data center increases. The RL mechanism is described further along with FIGS. 6-7.

FIGS. 2A-2B depict example graphs 202 and 204 depicting temporal patterns found within the performance clusters in an exemplary scenario according to an embodiment herein. As shown in the graphs 202 and 204, there lies a clear similarity in temporal patterns found within the performance cluster.

Similar to k-Means with DTW algorithm, k-means Soft-DTW clustering can also be used here to do the clustering. The best model is evaluated and the best performing algorithm on that specific datacenter's data can be chosen.

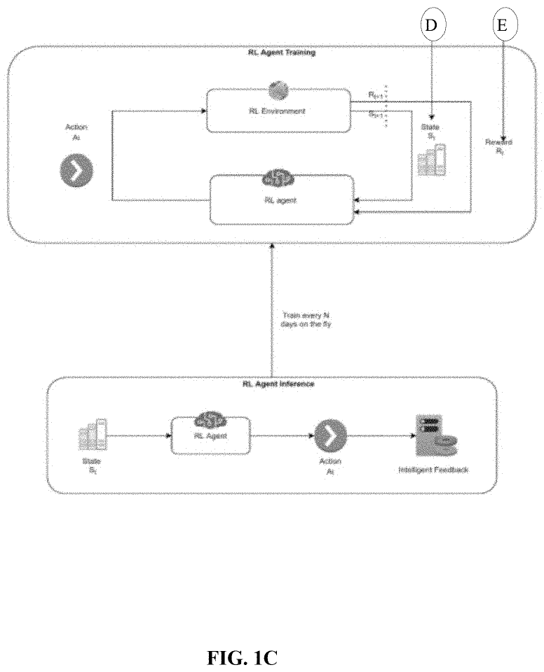

FIG. 3 illustrates a block diagram representation of clustering based on workload characterization by the system of the embodiments herein. The system retrieves workload data 302 that includes workloads running on a datacenter and clusters the workload 304 into k-groups based on similarities. The system draws workload classification 306 based on K-groups of clusters. This almost the same as the clustering discussed in the previous sections with the difference being here the data is not time series data so there is no need for dynamic time warping function. The input to the k-Means algorithm would be the average total runtime, CPU rate, max CPU rate, average memory usage and max memory usage, disk IO time, max disk space usage for each task/workload running in the dataset. Using the dataset described above, we can apply clustering for the runtime, CPU usage, memory usage and disk usage separately. If ‘t’ is the number of clusters obtained for runtime of the workloads, c in the number of clusters for CPU, in for memory and d for disk usage, then the total number of clusters can be the combination of all of these. To find the right number of clusters for each attribute, elbow method can be used here as well.

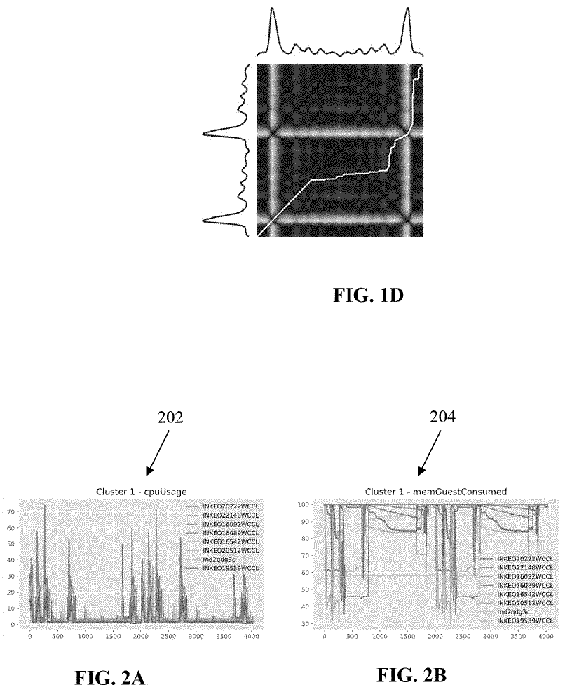

FIG. 4 depicts an exemplary graph 400 depicting workload clustering in google cloud trace dataset, according to an exemplary scenario, in accordance with an embodiment herein. An optimal value for k=2 forms the elbow of the curve. Once the clustering is done a table can be created for all combinations of the clusters based on how frequent workloads fall into the combination of each cluster. This describes the workload distribution of the datacenter. It can be very useful for analyzing the workloads for capacity planning. Because of the unsupervised nature of the clustering algorithm, it is required to manually analyze each cluster and label them as high, low or medium depending upon the nature of each cluster.

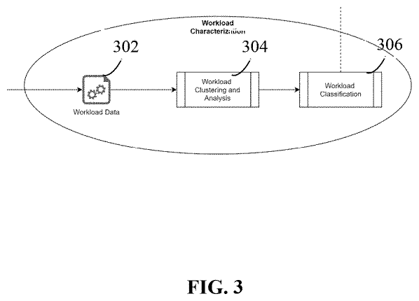

FIG. 5 depicts an exemplary graph 500 corresponding to a Google cluster-usage traces (GCT) 25 million (M) workloads and CPU clusters K=2. In the example below, one cluster corresponds to low values and the other for relatively high values. So, the workloads in the cluster clusters can be interpreted as high (H) and low (L). This step can be optional but once this is done with sufficient amount of data and its labels are decided from the clustering process, the workloads can be classified relatively accurately using any machine learning classification algorithm. The input data for the classification algorithm can be the usage metrics along with the resources on which it was made to run. The output from the model will be the one of the combinations of (t, c, m, s) indicating the workload characteristic. A number of classification algorithms like support vector machine (SVM)s, random forests, neural networks etc. can be evaluated on a specific datacenter's workload data and the best one can be chosen for classifying the workloads in the datacenter. Now that the resources and the workloads are clustered. More analytics like the kind of workloads running on specific VM or resource cluster can be presented to the user. These analytics can be very useful for managing the datacenter capacity because it gives a deeper look at both the resources and the workloads that are running in the datacenter.

Similar to the scoring done on the resources, the workload data can also be scored. The workloads can also be binned similarly and scored based on the densities respective to each bin. A higher score close to 1 will indicates that the workload demands more resources and close to 0 means the workloads demands less resources. This is an alternative method which doesn't need any manual supervision like in case of classification to label the clusters based on its properties. This can come in handy when training the RL agent, where this information about the workload can be fed into an observation space of an RL agent. This can help avoid any blind spots corresponding to the workloads to build the RL agent for optimizing the datacenter capacity.

FIG. 6 depicts reinforcement learning process being modelled as a loop, in accordance with an embodiment herein. In an embodiment herein, an RL agent (Agent) 602 receives a state S0 604 from the environment (in this case, an initial observation of the environment). Based on that state S0 604, the RL agent 602 takes an action A0 606. The action 606 can include, for example, increasing or decreasing the capacities. The environment 608 transitions to a new state S1 (Change in the resource utilization resulting in different efficiency scores). The environment 608 gives some reward R1 610 to the RL agent 602 (cumulative reward of all the efficiency scores). The RL loop outputs a sequence of states, actions and rewards. The goal of the RL agent 602 is to maximize the expected cumulative reward. Since, reinforcement learning is based on the idea of the reward hypothesis, all the goals can be described by the maximization of the expected cumulative reward. Therefore, in reinforcement learning, to have the best behavior, we need to maximize the expected cumulative reward. in this case maximizing the cumulative reward directly increases the overall efficiency of the data center.

FIG. 7 illustrates a markov decision process representing RL agent training 702, in accordance with an embodiment herein. The whole process of training the RL agent 602 can be represented as a markov decision process (MDP). A discounted MDP can be formally defined as a five-tuple M=(S, A, P, R, γ), where S is the set of environment states and A is the set of actions, P: S×A×S→[0, 1] is the transition probability function, which models the uncertainty in the evolution of states of the system based on the action taken by the agent, R: S×A→R is the reward function, and γ ∈ [0, 1] is the discount factor.

State Space: The state space for this problem includes the VMs, their respective capacities for CPU, Memory and Disk. Some statistical features for each VM like the current average utilizations and peaks. The efficiency scores of the VMs. It also includes the types of workloads running on each VM obtained as a result of the steps discussed in previous sections. The agent tweaks the capacities, the environment recomputes the efficiency scores and gives back a reward signal.

Action Space: At every step the action takes an action to receive a reward. It samples its actions from the action space every time. For this problem the action space is a set of discretized changes in capacities the agent can perform.

Observation Space: In this problem, the observation space is fully observable. The agent can observe the entire state space at an instance t. The features describing the current state of each VM and the workload types along with the capacities.

Rewards: The reward setting can vary depending upon how we want the agent to behave. Here the main aim is to maximize the overall efficiency score of the datacenter. The reward signal for each step the agent takes is the resultant efficiency score for that VM penalized by a negative factor if the change caused a decrease in efficiency. The final reward signal is the sum of all the efficiency scores. The tries to maximize the reward thus increasing the overall efficiencies while being penalized for inappropriate decisions.

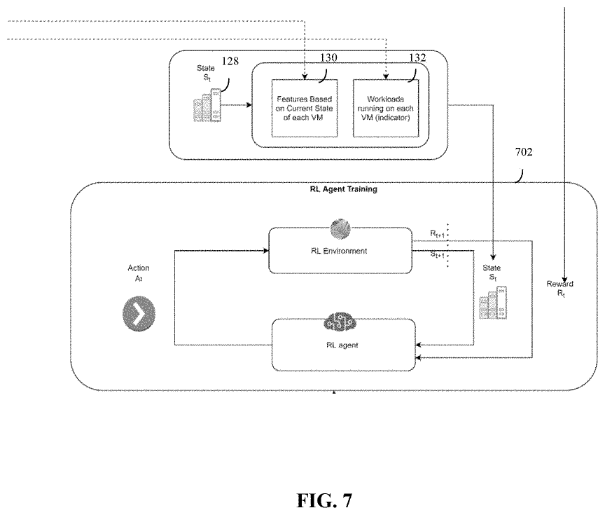

FIG. 8 depicts a block diagram representation of a process of iteratively training the RL agent, in accordance with an embodiment herein. In order to train the RL agent 602, is we define the state space, action space and the observation space as discussed in the previous sections. The agent is trained iteratively in an episodic manner. In each episode, the agent takes n steps, where n is the number of VMs in the datacenter. At the end of each episode, it receives a reward signal describing the actions. The process repeats for the specified number of training iterations. The RL agent 602 for this problem can be a Q-Learning algorithm or a variant of it that uses Deep Neural Network for predicting the actions—Deep Q Learning. These algorithms must be enough considering the simplicity of the problem at hand. Policy optimization algorithms can also be experimented with to see if they yield any significance improvements.

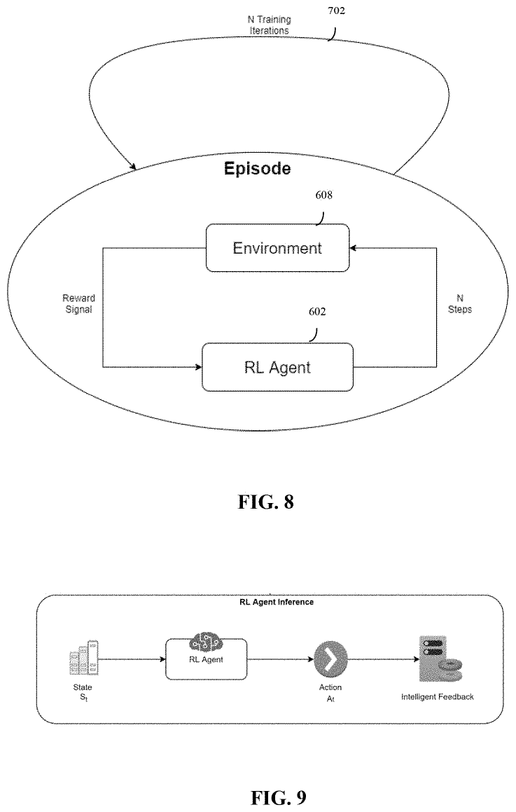

FIG. 9 is a block diagram representation of a process of RL agent inference, in accordance with an embodiment herein. The RL agent 602 can be used to make decisions. Once the RL agent 602 is trained and the performance is good enough, it can be used to make decisions in a real-world setting. Given the inputs, here the agent 602 is used to only estimate a possible optimal action that can increase the overall efficiency. The end user can be presented with an optimal action to take along with how the move will positively impact the current state of the datacenter. The action itself is determined by the trained RL agent 602. The RL agent 602 can be updated every few days.

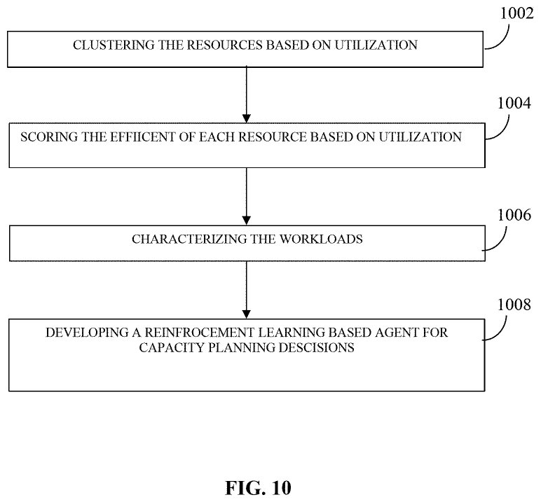

FIG. 10 is a flow diagram illustrating a method of capacity planning based on intelligent feedback and analytics, in accordance with an embodiment herein. At step 1002, one or more resources (such as virtual machines) are clustered based on utilization to identify and group together resources with similar behavior. At step 1004, efficiency of each resource is scored based on utilization or characterizing the resource type. At step 1006, system characterizes the workloads. At step 1008, the system develops a reinforcement learning based agent to help make capacity planning decisions based on the steps of clustering, efficiency scoring, and characterization.

The embodiments herein provide system and method for capacity planning based on intelligent feedback and analytics. The intelligent feedback along with the analytics provided in workload characterization and resource clustering helps an end user (datacenter manager) to make appropriate decisions to keep the datacenter performing efficiently. Additionally, the system and method of the present technology enables datacenter to elastically scale up and down in an effective way. Moreover, the system and method of the embodiments herein facilitates reduction in inefficient regions in the datacenter as the clusters and efficiency scores of the VMs can help stop inefficient regions in the datacenter. Also, the embodiments herein facilitate in understanding the type of workloads running in the datacenter which on its own can be used for analyzing application performances, capacity planning by studying certain workloads, it can help in a possible migrating of these services in future. Furthermore, the present technology enables maintaining the datacenter in a cost-effective manner as problematic areas can be easily spotted. Furthermore, the present technology helps in bringing down the carbon footprint of the datacenter by keeping it more efficient.

The foregoing description of the specific embodiments herein will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of the preferred embodiments herein, those skilled in the art will recognize that the embodiments herein can be practiced with modifications. However, all such modifications are deemed to be within the scope of the claims.

What is claimed is:

1. A system for capacity planning based on intelligent feedback and analytics in a datacenter comprising:
a. a clustering module configured to cluster plurality of resources based on utilization, to identify and group together the plurality of resources with similar behaviour, and wherein the plurality of resources comprises virtual machines or VMs;
b. an efficiency scoring module configured to score efficiency of each plurality of resources based on utilization, and wherein the efficiency score enables to spot inefficient regions in a datacenter, and wherein the datacenter is a large group of networked computer servers typically used by organizations for remote storage, processing, or distribution of large amount of data;
c. a workload characterization module configured to characterize at set of workloads to identify the nature of the set of workload, and wherein the set of workloads comprises applications or services or tasks that are running in the datacenter and consumes the plurality of resources; and
d. a reinforcement learning module configured to generate a reinforcement learning based agent or RL agent to make capacity planning decisions based on the inputs from clustering module, efficiency scoring module and the workload characterisation module, and wherein the reinforcement learning agent or RL agent is an algorithm interacting with the environment by means of taking actions, and wherein the action includes increasing or decreasing the capacity of plurality of resources.

2. The system according to claim 1, wherein the clustering the plurality of resources in the cluster module involves utilizing the plurality of resources historical time series data such as CPU, Memory and/or Disk input/output that are behaving in similar ways are grouped together based on the similarity scores.

3. The system according to claim 1, wherein clustering module is provided with the historical time series data as an input to TS (Time Series) clustering algorithm to generate K-clusters by means of k-Means algorithm based on utilization of the plurality of resources, and wherein the k-Means algorithm utilizes an additional input hyperparameter k along with historical time series data to generate K-clusters, and wherein the hyperparameter k denotes the number of clusters to be formed.

4. The system according to claim 3, wherein the K-clusters is used as an input to generate a cluster-wise analytics, and wherein the cluster-wise analytics generated by the K-clusters helps to provide common insights such as number of plurality of resources being underutilized, number of plurality of resources being overloaded, number of underutilized plurality of resources contributing to the electricity bill, number of host that contribute most to the costs while being underutilized and pans of the datacenter with identical load patterns.

5. The system according to claim 3, wherein the k-means algorithm is k-Means clustering with Dynamic Time Warping (DTW) or k-Means Soft-DTW.

6. The system according to claim 1, wherein the efficiency score is obtained by:
a. assigning thresholds or bins for scoring each plurality of resource such as 0-30 Low, 31-70 Medium and 70-100 High;
b. evaluating number of values that fall in assigned bins for each plurality of resources;
c. considering probabilities of values that fall within each assigned bin;
d. multiplying the probabilities tor each assigned bin with weights to obtain an efficiency score, and wherein the efficiency score helps to filter out low category and emphasizes higher categories essentially making the score high for high probability values in high category and low probability values in low category;
e. obtaining the efficiency score for all the plurality of resources separately following the steps (a-d); and
f. assigning average of efficiency score for all the plurality of resources as an overall score, and wherein the score ranges between 0 and 1, and wherein the score near to 1 indicates good utilization of plurality of resources, score of 0.5 indicates medium utilization of plurality of resources and score near to 0 indicates poor utilization of plurality of resources.

7. The system according to claim 1, wherein the characterization of set of workload includes performing workload clustering and analysis to generate workload classification, and wherein the workload classification helps in capacity management, optimizing performance and resource availability in the datacenter.

8. The system according to claim 1, wherein the data used for characterization of set of workload includes total runtime of each task, CPU, Memory and Disk IO peaks and averages during runtime.

9. The system according to claim 1, wherein the characterization of set of workloads comprises clustering-based characterization or scoring-based characterization to identify the workload distribution of the datacenter, and wherein the clustering-based characterization provides number of combinations of workload that are variable, and wherein the scoring-based characterization provides number of combinations of workload that are fixed.

10. The system according to claim 1, wherein the reinforcement learning agent or RL agent perceives a reward signal depending upon the actions taken by the RL agent, and wherein the reward signal comprises sum of all plurality of resources efficiency scores, and wherein the objective of the RL agent is to maximize the cumulative reward after multiple iterations to make most suitable capacity planning decisions over time, and wherein the capacity planning decisions increases the overall efficiency of the datacenter.

11. A method for capacity planning based on intelligent feedback and analytics in a datacenter comprising steps of:
a. clustering plurality of resources based on utilization to identify and group together the plurality of resources with similar behaviour, and wherein the plurality of resources comprises virtual machines or VMs;
b. calculating efficiency score for each plurality of resources based on utilization, wherein the efficiency score enables to spot inefficient regions in a datacenter, and wherein the datacenter is a large group of networked computer servers typically used by organizations for remote storage, processing, or distribution of large amount of data;
c. characterizing a set of workload to identify the nature of the set of workload, and wherein the set of workloads comprises applications or services or tasks that are running in the datacenter and consumes the plurality of resources; and
d. developing a reinforcement learning based agent or RL agent to make capacity planning decisions based on the inputs from clustering, scoring and characterizing the set of workload, and wherein the reinforcement learning agent or RL agent is an algorithm interacting with the environment by means of taking actions, and wherein the action includes increasing or decreasing the capacity of plurality of resources.

12. The method according to claim 11, wherein the clustering the plurality of resources involves utilizing the plurality of resources historical time series data such as CPU, Memory and/or Disk input/output that are behaving in similar ways are grouped together based on the similarity scores.

13. The method according to claim 11, wherein during the clustering of the plurality of resources the historical time series data is given as an input to TS (lime Series) clustering algorithm to generate K-clusters by means of k-Means algorithm based on utilization of the plurality of resources, and wherein the k-Means algorithm utilizes an additional input hyperparameter k along with historical time series data to generate K-clusters, and wherein the hyperparameter k denotes the number of clusters to be formed.

14. The method according to claim 13, wherein the K-clusters is used as an input to generate a cluster-wise analytics, and wherein the cluster-wise analytics generated by the K-clusters helps to provide common insights such as number of plurality of resources being underutilized, number of plurality of resources being overloaded, number of underutilized plurality of resources contributing to the electricity bill, number of host that contribute most to the costs while being underutilized and parts of the datacenter with identical load patterns.

15. The method according to claim 11, wherein the calculating efficiency score comprises the step of:
a. assigning thresholds or bins for scoring each plurality of resource such as 0-30 Low, 31-70 Medium and 70-100 High;
b. evaluating number of values that fall in assigned bins for each plurality of resources;
c. considering probabilities of values that fall within each assigned bin;
d. multiplying the probabilities for each assigned bin with weights to obtain an efficiency score, and wherein the efficiency score helps to filter out low category and emphasizes higher categories essentially making the score high for high probability values in high category and low probability values in low category;
e. obtaining the efficiency score for all the plurality of resources separately following the steps (a-d); and
f. assigning average of efficiency score for all the plurality of resources as an overall score, and wherein the score ranges between 0 and 1, and wherein the score near to 1 indicates good utilization of plurality of resources, score of 0.5 indicates medium utilization of plurality of resources and score near to 0 indicates poor utilization of plurality of resources.

16. The method according to claim 11, wherein the characterizing the set of workload includes performing workload clustering and analysis to generate workload classification, and wherein the workload classification helps in capacity management, optimizing performance and resource availability in the datacenter.

17. The method according to claim 11, wherein the data used for characterizing the set of workload includes total runtime of each task, CPU, Memory and Disk IO peaks and averages during runtime.

18. The method according to claim 11, wherein the characterizing the set of workloads comprises clustering-based characterization or scoring-based characterization to identify the workload distribution of the datacenter, and wherein the clustering-based characterization provides number of combinations of workload that are variable, and wherein the scoring-based characterization provides number of combinations or workload that are fixed.

19. The method according to claim 11, wherein the reinforcement learning agent or RL agent perceives a reward signal depending upon the actions taken by the RL agent, and wherein the reward signal comprises sum of all plurality of resources efficiency scores, and wherein the objective of the RL agent is to maximize the cumulative reward after multiple iterations to make most suitable capacity planning decisions over time, and wherein the capacity planning decisions increases the overall efficiency of the datacenter.
